(19) United States
(12) Patent Application Publication
(10) Pub. No.: US 2023/0187656 A1
(43) Pub. Date: Jun. 15, 2023

(54) CURRENT COLLECTOR FOR SILICON ANODE

(71) Applicant: ARMOR, NANTES (FR)

(72) Inventors: Simon BERTHOME, REZE (FR); Pierre GUICHARD, NANTES (FR)

(21) Appl. No.: 17/916,497

(22) PCT Filed: Mar. 31, 2021
(86) PCT No.: PCT/EP2021/058509

§ 371 Date: Sep. 30, 2022

(30) Foreign Application Priority Data
Apr. 1, 2020 (FR) FR20 03233

(51) Int. Cl. H01M 4/70; H01M 4/38; H01M 4/04; H01M 4/134; H01M 4/1395

(52) U.S. Cl. CPC H01M 4/70; H01M 4/134; H01M 4/386; H01M 4/0404; H01M 4/1395; H01M 2004/027

(57) ABSTRACT

Disclosed is a current collector for an anode, the current collector including: a substrate with a first face; and at least one interfacing layer with a thickness less than 10 micrometers, preferentially less than 6 micrometers, in contact with the first face of the substrate, the interfacing layer having a roughness the depth of which is included between 0.5 micrometers and 10 micrometers.

### TECHNICAL FIELD OF THE INVENTION

The present invention relates to a current collector for an anode. The invention further relates to a cell and to an energy storage device comprising such current collector. The present invention further relates to a corresponding manufacturing method for the current collector.

The present invention further relates to an anode for an electrochemical cell. The invention further relates to a cell and to an energy storage device comprising such anode. The present invention further relates to a manufacturing method for said anode.

### BACKGROUND OF THE INVENTION

An electrochemical storage battery conventionally comprises a positive electrode, a negative electrode, an electrolyte, and current collectors for each electrode. The combination of a negative electrode and of a current collector forms an anode whereas the combination of a positive electrode and of a current collector forms a cathode.

The operating principle of such cells is based on the reversible storage of electrical energy as chemical energy by using two separate and coupled electrochemical reactions. The positive and negative electrodes bathe in the electrolyte and are the seat of so-called Faraday type electrochemical reactions. In particular, the electrodes are made of active materials for storing and removing ions via oxidation and reduction reactions.

The electrodes are made according to a composition, the composition including mainly one or a plurality of active material(s) (>70% by weight), conducting particles providing good transport of electrons toward all the active materials, and a binder which provides the cohesion of the particles, along with the adhesion to the current collector.

The two electrodes, positive and negative, are then ionically linked by an electrolyte. The electrolyte can be liquid, in the form of a gel or solid.

Due to the intrinsic ion migration functioning of cells, electrodes need materials apt to insert and/or remove ions. Lithium technologies have the best features in terms of mass and volume energy densities. Such technologies are thus preferentially chosen for nomadic applications, such as mobile telephony or laptop computers, and also for the development of new electric vehicles (EV) and stationary Energy Storage Systems (ESS) requiring large storage capacities and long service lives.

Silicon, as the active material of the anode, has a storage capacity for lithium ions greater than the storage capacity of graphite. During the first cycles of use, the liquid electrolyte and lithium are deposited on the surface of the active material and decompose to form a layer, called solid electrolyte interphase (SEI). The lithium deposited at such location is no longer available for transporting lithium ions between the electrodes.

However, silicon anodes can be damaged by deformations and fractionation of the active material, caused by volume changes which can reach 300%. Indeed, during the functioning of the cell, when the lithium ions are intercalated, the active material of the anode expands, and when the lithium ions are removed, the active material contracts. Such changes in volume can further result in peeling, or a peeling of the SEI and a new decomposition of the electrolyte, accompanied by additional deposition of lithium, leading to the formation of a new SEI.

### SUMMARY OF THE INVENTION

There is thus a need for an anode for an electrochemical cell which can be used for producing an electrochemical cell with a longer service life.

There is a further need for a current collector for anode making for providing improved properties, in particular improved adhesion to the electrode and/or decreased electrical resistance between the substrate and the electrode.

To this end, a current collector for anode is proposed, the current collector including:
a substrate with a first face, and
at least one interfacing layer with a thickness less than 10 micrometers, preferentially less than 6 micrometers, in contact with the first face of the substrate, the interfacing layer having a roughness the depth of which is comprised between 0.5 micrometers and 10 micrometers.

Such a collector has improved properties in terms of adhesion and/or reduced electrical resistance.

It should be noted that such performances are better if one or a plurality of interfacing layers are added between a substrate and an electrode layer for improving the adhesion between the two elements and/or to reduce the mechanical stresses within the electrode. Such a technique is known e.g. from documents U.S. Pat. No. 2012/107684, WO 2009/054987, U.S. Pat. No. 2009/0061319 and U.S. Pat. No. 2017/271678.

However, even if an interfacing layer gives good adhesion of the electrode to the substrate, and hence a better electrical interface, same adds an electrical resistance therewithin due to the conductivity limit of the components thereof.

The roughness of the interfacing layer of the present collector solves the technical problem, in particular, by generating better electrical percolation within the electrode and by increasing the electron exchange surface with the current collector.

It should be noted that this does not concern a coating layer the surface state of which reproduces only the state of the substrate on which same is deposited, as described in document U.S. Pat. No. 2013/0115510, but indeed a layer with an own surface state thereof. Such surface state is controlled and can be modulated, e.g. due to the composition of the layer, in order to obtain the best electrochemical performance.

According to particular embodiments, the current collector comprises one or a plurality of the following features, taken individually or in all technically possible combinations:
the interfacing layer having a second face in contact with the first face of the substrate, the second face of the interfacing layer having a surface area and the first face of the substrate having a surface area, the ratio between the surface area of the second face of the interfacing layer and the surface area of the first face of the substrate being comprised between 0.1 and 1.
the interfacing layer being made by coating a second composition, the second composition comprising a second binder material and a second conducting additive.
the interfacing layer consisting of an array including a plurality of elements arranged on the first face of the substrate, each element being separated from another adjacent element by a distance comprised between 200 micrometers and 2500 micrometers, the distance separating two adjacent elements being the smallest distance between a point of one element and a point of a second element adjacent to the first element.
the interfacing layer being produced by coating a third composition, the third composition comprising a third conducting additive and, if appropriate, a third binder material.
each element having a base, the base of each element being a polygon or a disk or an oval.
the base of the elements of the interfacing layer having a level of coverage of the first face of the substrate comprised between 0.1 and 0.9, preferentially between 0.2 and 0.5.
each element having a height less than or equal to 10 micrometers.
the current collector comprising at least a first interfacing layer, the first interfacing layer having a second face in contact with the first face of the substrate, the second face of the interfacing layer having a surface area and the first face of the substrate having a surface area, the ratio between the surface area of the second face of the interfacing layer and the surface area of the first face of the substrate being comprised between 0.1 and 1. The current collector comprising at least a second interfacing layer, the second interfacing layer consisting of an array comprising a plurality of elements arranged on the first face of the substrate, each element being separated from another adjacent element by a distance comprised between 200 micrometers and 2500 micrometers, the distance separating two adjacent elements being the smallest distance between a point of a first element and a point of a second element adjacent to the first element, the first interfacing layer and the second interfacing layer being overlaid one on top of the other.

The present description further relates to an electrochemical cell comprising a current collector such as described above.

The present description further relates to a manufacturing method for a current collector for an anode, the method comprising:
a step of providing a substrate with a first face, and
a step of depositing, by coating at least one interfacing layer on the first face of the substrate, the interfacing layer having a thickness less than 10 micrometers, preferentially less than 6 micrometers, the interfacing layer having a roughness the depth of which is comprised between 0.5 micrometers and 10 micrometers.

An anode for an electrochemical cell is further proposed, the anode including a substrate with a first face, an electrode produced according to a first composition, the first composition including an intercalation material, a first binder material and a first conducting additive, the intercalation material comprising silicon. The electrode having one face, the first face of the substrate and the face of the electrode being opposite each other. The anode including at least one interfacing layer with a thickness less than 10 micrometers, preferentially less than 6 micrometers, arranged between the substrate and the electrode and in contact with the first face of the substrate and the face of the electrode.

According to other particular embodiments, the anode comprises one or more of the following features, taken individually or according to all technically possible combinations:
the interfacing layer having a first face in contact with the face of the electrode, the first face of the interfacing layer having a roughness the depth of which is comprised between 10 nanometers and 10 micrometers.
the interfacing layer having a second face in contact with the first face of the substrate, the second face of the interfacing layer having a surface area and the first face of the substrate having a surface area, the ratio between the surface area of the second face of the interfacing layer and the surface area of the first face of the substrate being comprised between 0.1 and 1.
the interfacing layer being made by coating a second composition, the second composition comprising a second binder material and a second conducting additive.
the interfacing layer consisting of an array including a plurality of elements arranged on the first face of the substrate, each element being separated from another adjacent element by a distance comprised between 200 micrometers and 2500 micrometers, the distance separating two adjacent elements being the smallest distance between a point of one element and a point of a second element adjacent to the first element.
the interfacing layer being produced by coating a third composition, the third composition comprising a third conducting additive and, if appropriate, a third binder material.
each element having a base, the base of each element being a polygon or a disk or an oval.
the base of the elements of the interfacing layer having a level of coverage of the first face of the substrate comprised between 0.1 and 0.9, preferentially between 0.2 and 0.5.
each element having a height less than or equal to 10 micrometers.
the anode comprising at least a first interfacing layer, the first interfacing layer having a first face in contact with the face of the electrode, the first face of the interfacing layer having a roughness the depth of which is comprised between 10 nanometers and 10 micrometers. The anode comprising at least a second interfacing layer, the second interfacing layer consisting of an array comprising a plurality of elements arranged on the first face of the substrate, each element being separated from another adjacent element by a distance comprised between 200 micrometers and 2500 micrometers, the distance separating two adjacent elements being the smallest distance between a point of a first element and a point of a second element adjacent to the first element. The first interfacing layer and the second interfacing layer being overlaid one on top of the other.
the silicon concentration of the intercalation material being greater than or equal to 30%, preferentially greater than or equal to 60% by weight.
the intercalation material being silicon.

The present description further relates to an electrochemical cell including an anode such as described above.

The present description further describes an energy storage device including at least one electrochemical cell such as described above.

The present description further relates to a method for manufacturing an anode for an electrochemical cell, the method comprising a step of providing a substrate with a first face, a step of depositing by coating, at least one interfacing layer on the first face of the substrate, the interfacing layer having a thickness less than 10 micrometers, preferentially less than 6 micrometers. The method further includes a step of preparing a first composition including an intercalation material, a first binder material and a first conducting additive, the intercalation material comprising silicon, and a step of depositing by coating the first composition onto the interfacing layer for producing an electrode with one face, the first face of the substrate and the face of the electrode being opposite, and the interfacing layer being in contact with the first face of the substrate and the face of the electrode.

### BRIEF DESCRIPTION OF DRAWINGS

Other features and advantages of the invention will appear upon reading hereinafter the description of the embodiments of the invention, given only as an example, and making reference to the following drawings:

- FIG. 1 is a schematic representation of an electrochemical cell including an anode,

- FIG. 2, a schematic side view of a section of the anode of the electrochemical cell including an interfacing layer,

- FIG. 3, a schematic side view of a section of another example of an anode of the electrochemical cell including another example of an interfacing layer,

- FIG. 4, a schematic representation of the top of a section of a part of the interfacing layer of an example of anode,

- FIG. 5, a schematic representation of the top of a section of a part of the interfacing layer of another example of anode,

- FIG. 6, a schematic representation of the top of a section of a part of the interfacing layer of a further example of anode,

- FIG. 7, a schematic representation of the top of a section of a part of the interfacing layer of a further example of anode example, and

- FIG. 8, a schematic side view of a section of another example of anode of the electrochemical cell including two interfacing layers.

- FIG. 9, a schematic side view of a section of another example of anode of the electrochemical cell including two interfacing layers.

### DETAILED DESCRIPTION OF EMBODIMENTS

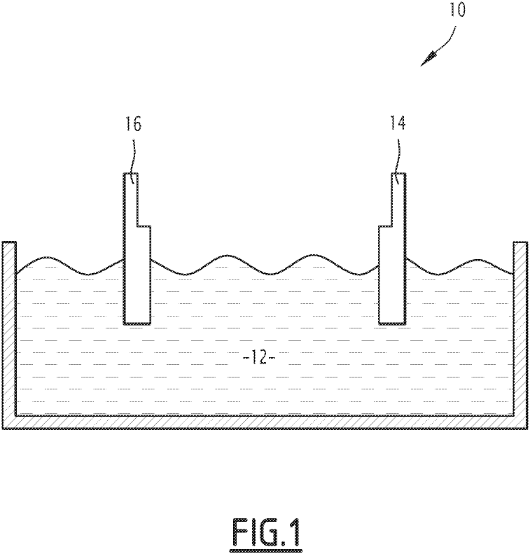

An electric cell 10 is shown in FIG. 1.

The cell 10 is intended to be connected to other electric cells for forming an energy storage device, in particular an electric generator with desired voltage and capacity.

Such a generator is called a cell battery or more simply a battery.

The cell 10 uses a reversible energy conversion technique for storing energy and returning same later.

The described cell 10 uses an electrochemical reaction, the cell 10 is an electrochemical cell.

According to the example described, the battery cell 10 is a lithium-ion cell intended for a lithium-ion battery.

The cell 10 comprises an electrolyte 12, a cathode 14, and an anode 16.

The cell 10 functions as an electrochemical cell through the interaction between the electrolyte 12, the cathode 14, and the anode 16.

The electrolyte 12 consists of different ionic salts which bring ions used for the charge storage reactions or Faraday type reactions, of carbonates and of a solvent or mixture of solvents for solubilizing the ions.

The ionic salts are chosen from lithium hexafluorophosphate (LiPF₆), lithium bis(trifluoromethanesulfonyl)imide salt (LiTFSI), lithium tetrafluoroborate (LiBF₄), lithium bis oxalate borate (LiBOB), lithium nitrate (LiNO₃) and lithium difluorooxalatoborate (LiDFOB).

The carbonates are e.g. propylene carbonate (PC), ethylene carbonate (EC), dimethyl carbonate (DMC), ethyl methyl carbonate (EMC) and diethyl carbonate (DEC).

Further carbohydrates are, in smaller proportions, fluoroethylene carbonate (FEC), vinylene carbonate (VC), methyl acetate, methyl formate, acetonitrile, tetrahydrofuran, gamma-butyrolactone, and binary or ternary or even quaternary mixtures thereof, as well as ionic liquids.

The cathode 14 includes an active material.

The active material of the cathode 14 conventionally consists of lithium sulfur (LIS) and/or at least one lithiated metal oxide, the lithiated metal oxide being chosen e.g. from lithium-cobalt oxide LiCoO₂ (LCO), lithium-nickel-cobalt-manganese oxide LiNiMnCoO₂ (NMC), lithium-nickel-cobalt-aluminum oxide LiNiCoAlO₂ (NCA), lithium-manganese oxide LiMnO₄ (LMO), lithium-iron-phosphorus oxide LiFePO₄ (LFP), lithium-nickel-manganese oxide Li(LiNiMn)O₂, lithium manganese iron phosphate (LMFP), and lithium-nickel-manganese oxide LiNiMnO (LNMO).

Other examples of active material of the cathode 14 are possible, e.g. same suitable for sodium-ion batteries.

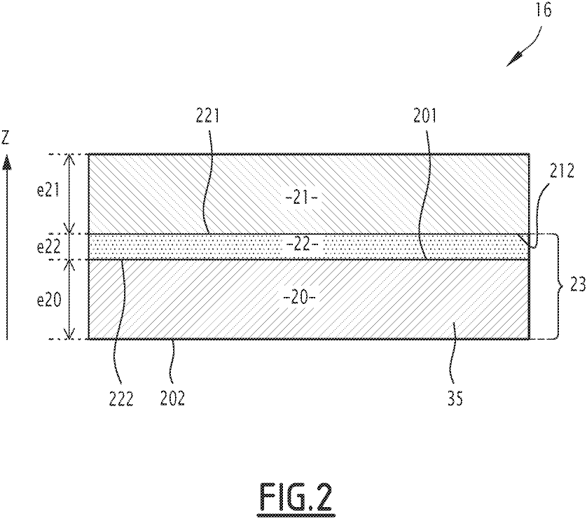

The anode 16 is shown in more detail in FIG. 2.

The anode 16 includes a substrate 20, an electrode 21 and an interfacing layer 22.

The substrate 20, the electrode 21 and the interfacing layer 22 form a stack of layers along a stacking direction denoted by Z, the interfacing layer 22 being arranged between the substrate 20 and the electrode 21.

The substrate 20, the interfacing layer 22, and the electrode 21 are overlaid.

The substrate 20 and the interfacing layer 22 form a current collector of the anode 16.

The substrate 20 and the interfacing layer 22 form the current collector 23.

Throughout the description, each feature or embodiment relates without distinction to the anode 16 or the current collector 23.

The substrate 20 has a first face 201 perpendicular to the stacking direction Z.

The substrate 20 has a thickness e20 comprised between 1 and 20 micrometers (µm), preferentially equal to 10 µm, the thickness e20 being measured along the stacking direction Z.

Everywhere hereinafter, “a value is comprised between A and B” means that the value is greater than or equal to A and less than or equal to B.

Everywhere hereinafter, the value of the thickness e of a layer is measured along the stacking direction Z.

The substrate 20 includes a metal foil 35.

The metal foil 35 is made e. g. of iron, copper, aluminum, nickel, titanium or stainless steel.

The electrode 21 is in contact with the electrolyte 12 of the cell 10.

The electrode 21 has a face 212 perpendicular to the stacking direction Z.

The face 212 of the electrode 21 is opposite the first face 201 of the substrate 20.

The electrode 21 is arranged on the interfacing layer 22.

The electrode 21 has a thickness e21 comprised between 10 µm and 150 µm .

The electrode 21 is formed by depositing a first composition C1 on the interfacing layer 22. Preferentially, the electrode 21 is formed by coating the first composition C1 on the interfacing layer 22.

The first composition C1 includes an intercalation material MI, a first binder material ML1 and a first conducting additive AC1.

The intercalation material is further referred to by the term “active material”.

The intercalation material MI comprises at least silicon. The silicon concentration in the intercalation material MI is greater than or equal to 30% by weight of the intercalation material MI, preferentially greater than or equal to 60% by weight of the intercalation material MI, and is advantageously equal to 100% by weight of the intercalation material MI.

The silicon of the intercalation material MI is in the form of an overall spherical particle with a diameter comprised between 5 nanometers (nm) and 500 nm, preferentially between 10 nm and 200 nm. Alternatively, the silicon of the intercalation material MI is in the form of flakes or fibers. The silicon of the intercalation material MI can be coated with carbon. When the silicon concentration in the first intercalation material MI1 is strictly less than 100%, the intercalation material MI further comprises a material chosen from mesophase microbeads, commonly referred to by the name “MesoCarbon MicroBeads” (MCMB), artificial or natural graphites, graphitic materials such as soft carbon or hard carbon, lithiated titanate-based compounds, such as Li₄Ti₅O₁₂ (also referred to by the acronym LTO) and compounds containing silicon, tin or alloys.

The first composition C1 comprises a concentration by weight of intercalation material MI greater than or equal to 50%, preferentially greater than or equal to 60%, advantageously between 60% and 93%, with respect to the weight of the composition C1.

The silicon of the electrode 21 is in the form of a dispersion of particles of pure silicon and/or silicon oxide SiOₓ within the material of the anode 16 (x being an integer equal to 1 or 2). The silicon and/or silicon oxide particles of the electrode 21 are not covalently bonded to another chemical element, such as e. g. hydrogen. If the silicon has been oxidized, the silicon particles are mainly composed of pure Si and coated with SiOₓ.

Everywhere hereinafter, the mass content of an element of a composition is calculated with respect to the weight of the total composition.

The choice of the first binding material ML1 varies considerably provided that the first binding material ML1 is inert with respect to the other materials of the electrode 21.

The first binder material ML1 is a material, preferentially a polymer, which can be used for facilitating the use of the electrodes during the manufacture thereof.

The first binder material ML1 comprises one or a plurality of polymers chosen from thermoplastic polymers, thermosetting polymers, elastomers and a mixture thereof.

Examples of thermoplastic polymers comprise, and are not limited to, polymers resulting from the polymerization of aliphatic or cycloaliphatic vinyl monomers, such as polyolefins (among which polyethylenes or further polypropylenes), polymers resulting from the polymerization of aromatic vinyl monomers, such as polystyrenes, polymers resulting from the polymerization of acrylic and/or (meth)acrylate monomers, polyamides, polyetherketones and polyimides.

Examples of thermosetting polymers comprise, but are not limited to, thermosetting resins (such as epoxy resins, polyester resins) mixed, if appropriate, with polyurethanes or polyether polyols.

Examples of elastomeric polymers comprise, but are not limited to, natural rubbers, synthetic rubbers, styrene butadiene copolymers (also known under the abbreviation “SBR”), ethylene-propylene copolymers (also known under the abbreviation “EPM”) and silicones.

According to a particular embodiment, the first binder material ML1 is a mixture of thermoplastic polymer(s), thermosetting polymer(s) and/or elastomeric polymer(s).

Other suitable first binder materials ML1 comprise cross-linked polymers, such as same manufactured from polymers having carboxyl groups and cross-linking agents.

Other suitable first binding materials ML1 comprise cellulose derivatives.

The first composition C1 comprises a concentration by weight of first binder material ML1 which is less than or equal to 30%, preferentially less than or equal to 20%.

The first conducting additive AC1includes one or a plurality of types of conducting elements so as to improve electronic conductivity.

Examples of conducting elements include, but are not limited to, conducting carbons, graphites, graphenes, carbon nanotubes, activated carbon fibers, non-activated carbon nanofibers, metal flakes, metal powders, metal fibers and electrically conducting polymers.

A nanofiber is defined as a fiber with a diameter with a maximum dimension comprised between 1 nm and 200 nm and extending along a direction normal to said diameter.

A nanotube is defined as a tube with an outer diameter with a maximum dimension comprised between 1 nm and 100 nm and extending along a direction normal to said diameter.

The first composition C1 comprises a concentration by weight of first conducting additive AC1 less than or equal to 20%, preferentially less than 10%.

The thickness e21 of the electrode 21 varies as a function of the quantity of silicon contained in the electrode 21.

The higher the quantity of silicon contained in the electrode 21, the lower the thickness e21 of the electrode 21. Thus, a higher quantity of silicon increases the energy density of the anode 16.

In the example described, the electrode 21 is separated from the substrate 20 by the interfacing layer 22.

The interfacing layer 22 has a first face 221 in contact with the face 212 of the electrode 21, and a second face 222 in contact with the first face 201 of the substrate 20.

The first face 221 and the second face 222 of the interfacing layer 22 are perpendicular to the stacking direction Z and parallel to each other.

The interfacing layer 22 has a thickness e22 which is less than or equal to 10 µm . Preferentially, the thickness e22 is greater than or equal to 10 nm. More preferentially, the thickness e22 is greater than or equal to 100 nm.

Advantageously, the thickness e22 is comprised between 10 nm and 3 µm .

The interfacing layer 22 is produced by depositing a second composition C2 onto the substrate 20. Preferentially, the interfacing layer 22 is produced by coating the second composition C2 over the first face 201 of the substrate 20.

The second composition C2 includes a second binder material ML2 and a second conducting additive AC2.

The second conducting additive AC2 comprises one or a plurality of types of conducting elements used for improving electronic conductivity.

For example, the second conducting additive AC2 is chosen from carbon, carbon black, graphite, graphene, carbon nanotubes, activated carbon fibers, non-activated carbon nanofibers, metal flakes, metal powders, metal fibers and electrically conducting polymers.

Preferentially, the second conducting additive AC2 is chosen, in a non-limiting manner, from carbon nanofibers and carbon nanotubes.

The second composition C2 comprises a concentration by weight of a second conducting additive AC2 greater than or equal to 20%.

Preferentially, the second composition C2 comprises a concentration by weight of a second conducting additive AC2 less than or equal to 70%.

Advantageously, the second composition C2 comprises a concentration by weight of a second conducting additive AC2 of between 30% and 60%.

The choice of the second binder material ML2 is not particularly limited as long as the second binder material ML2 is inert with respect to the other materials of the second composition C2.

The second binder material ML2 comprises one or a plurality of polymers selected from thermoplastic polymers, thermosetting polymers, elastomers and mixtures thereof.

Examples of thermoplastic polymers comprise, and are not limited to, polymers resulting from the polymerization of aliphatic or cycloaliphatic vinyl monomers, such as polyolefins (among which polyethylenes or further polypropylenes), polymers resulting from the polymerization of aromatic vinyl monomers, such as polystyrenes, polymers resulting from the polymerization of acrylic and/or (meth)acrylate monomers, polyamides, polyetherketones and polyimides.

Examples of thermosetting polymers comprise, but are not limited to, thermosetting resins (such as epoxy resins, polyester resins) mixed, if appropriate, with polyurethanes or polyether polyols.

Examples of elastomeric polymers comprise, but are not limited to, natural rubbers, synthetic rubbers, styrene butadiene copolymers (also known under the abbreviation “SBR”), ethylene-propylene copolymers (also known under the abbreviation “EPM”) and silicones.

Other suitable second binder materials ML2 comprise cross-linked polymers, such as same manufactured from polymers having carboxyl groups and cross-linking agents.

Other suitable second binding materials ML2 comprise cellulose derivatives.

The second composition C2 comprises a concentration by weight of a second binder material ML2 greater than or equal to 30%.

Preferentially, the second composition C2 comprises a concentration by weight of a second binder material ML2 less than or equal to 80%.

Advantageously, the second composition C2 comprises a concentration by weight of a second binder material ML2 of between 40% and 70%.

The interfacing layer 22 is characterized by the roughness of the first face 221 of the interfacing layer 22.

By definition, the roughness of the first face 221 of the interfacing layer 22 represents the amplitude of the reliefs of the first face 221 of the interfacing layer 22. The amplitude of the reliefs of the first face 221 of the interfacing layer 22 corresponds to the distance between the highest point and the lowest point of said reliefs, also called the peak-to-valley distance and denoted Rt.

The reliefs of the first face 221 of the interfacing layer 22 can also be incorrectly defined as defects of the first face 221 of the interfacing layer 22.

The amplitude of the reliefs of the first face 221 of the interfacing layer 22 has a depth comprised between 10 nm and 10 µm , preferentially between 2 µm and 9 µm . The amplitude of the reliefs of the first face 221 of the interfacing layer 22 can further have a a depth comprised between 0.5 µm and 9 µm , preferentially comprised between 0.5 µm and 8 µm , more preferentially comprised between 0.5 µm and 6 µm , advantageously comprised between 1 µm and 6 µm .

The reliefs of the first face 221 of the interfacing layer 22 are the consequence of the mixing of the constituents of the second composition C2. The second conducting additive AC2 and the second binder material ML2 are chosen so that the entanglement of the constituents generates reliefs in a random and relatively homogeneous manner over the total surface of the first face 221 of the interfacing layer 22.

The mass quantities of the second conducting additive AC2 and of the second binder material ML2 are used for modulating the roughness of the first face 221 of the interfacing layer 22.

The size and shape of the particles of the second conducting additive AC2 are further used for modulating the roughness of the first face 221 of the interfacing layer 22. The smaller the surface areas of the particles of the second conducting additive AC2, the smaller the amplitude of the reliefs of the first face 221 of the interfacing layer 22.

Furthermore, particles in the form of flakes or fibers are used for generating a greater amplitude of the reliefs.

In a variant, the roughness of the first face 221 of the interfacing layer 22 is modified by a surface treatment.

The roughness of the interfacing layer 22 is e.g. modified by the use of a plasma torch on the surface of the first face 221 of the interfacing layer 22.

The roughness of the first face 221 of the interfacing layer 22 is determined by white light interferometry measurement, e.g. by means of a nanometric non-contact surface topography station (OptoSurf brand). The topography station is used for reconstituting the first face 221 of the interfacing layer 22 in 2D and 3D and then for calculating the roughness thereof.

The roughness of the first face 221 of the interfacing layer 22 is defined from at least two distinct zones of the first face 221 of the interfacing layer 22.

The roughness of the first face 221 of the interfacing layer 22 is equal to the average of at least two relief amplitude values, each relief amplitude value corresponding to a distinct zone of the first face 221 of the interfacing layer 22. The relief amplitude of a distinct zone of the first face 221 of the interfacing layer 22 represents the distance between the highest point and the lowest point of said zone. The surface area of each distinct zone of the first face 221 of the interfacing layer 22 is e.g. 40,000 µm².

In the example proposed, the interfacing layer 22 entirely covers the surface.

In a variant, the interfacing layer 22 is perforated. The first face 201 of the substrate 20 is thus not entirely covered by the interfacing layer 22.

The second face 222 of the interfacing layer 22 has a surface area A22.

The first face 201 of the substrate 20 has a surface area A201.

The interfacing layer 22 is characterized by a level of covering R(I/s) of the face 201 of the substrate 20.

The covering ratio R(I/s) corresponds to the ratio between the surface area A22 of the second face 222 of the interfacing layer 22 and the surface area A201 of the first face 201 of the substrate 20 and is calculated according to the following formula:

$$\text{R} \left(\text{I} / \text{s}\right) = \text{A22} / \text{A201}$$

The covering ratio R(I/s) is comprised between 0.1 and 1. Preferentially, the covering ratio R(I/s) is comprised between 0.3 and 1. Advantageously, the covering ratio R(I/s) is comprised between 0.7 and 1. Preferentially further, the covering ratio R(I/s) is strictly less than 1, preferentially comprised between 0.1 and 0.9, advantageously between 0.7 and 0.9.

The functioning of the anode 16 is in accordance with the functioning an anode of the prior art.

The interfacing layer 22 improves the interface between the substrate 20 and the electrode 21.

In particular, the thickness less than 10 µm of the interfacing layer 22 can be advantageously used for improving the interface between the substrate 20 and the electrode 21 and for decreasing the electrical resistance between the substrate 20 and the electrode 21.

The presence of the interfacing layer 22 between the substrate 20 and the electrode 21 can be used for improving the adhesion between the different layers of the anode 16, which significantly improves the efficiency thereof.

Furthermore, the perforated appearance of the interfacing layer 22 and the roughness of the second face 222 of the interfacing layer 22 can be used for decreasing the electrical resistance between the substrate 20 and the electrode 21. A high resistance acts as a barrier against the transfer of electrons during the cycling of the cell 10.

The interfacing layer 22 thus has a major effect on the electronic conductivity of the anode 16, because same provides a better interface between the substrate 20 and the electrode 21 and preserves good electrical contact between the substrate 20 and the electrode 21.

The presence of the interfacing layer 22 further improves the conduction path.

The electrochemical performance of the anode 16 is thus significantly improved by the presence of the interfacing layer 22.

The improvement of the interface resulting from the perforated appearance of the interfacing layer 22 and the roughness of the second face 222 of the interfacing layer 22 arranged between the substrate 20 and the electrode 21 further limits the deterioration and delamination of the anode 16, caused by the volume expansion of silicon particles during the charging and discharging cycles of the cell 10. The cycling capacity retention and the service life of the anode 16 are thus improved.

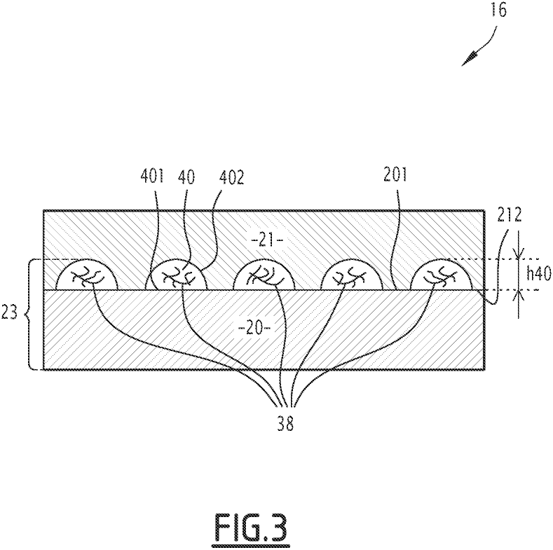

According to a variant shown in FIG. 3, the interfacing layer 22 consists of an array 38 comprising a plurality of elements 40.

The elements 40 are uniformly distributed over the entire surface of the first face 201 of the substrate 20.

The number of elements 40 is denoted by n.

According to the example described, each element 40 is identical.

Each element 40 of the interfacing layer 22 is in contact with the first face 201 of the substrate 20 and with the face 212 of the electrode 21.

Each element 40 of the interfacing layer 22 has a base 401.

The base 401 of each element 40 is in contact with the first face 201 of the substrate 20.

Each base 401 is a disk having a larger diameter of length d1. The diameter d1 varies between 200 µm and 1000 µm , preferentially between 500 µm and 900 µm.

Each base 401 has a center.

Each base 401 has a surface area A401.

The surface area A401 of each base 401 is comprised between 0.03 square millimeters and 0.8 square millimeters.

Each element 40 is a volume generated from the base 401 thereof.

In the example described, the elements 40 are domes.

Each element 40 of the interfacing layer 22 has a height H40 less than or equal to 10 µm. Preferentially, each element 40 of the interfacing layer 22 has a height H40 less than or equal to 6 µm . Preferentially, further, each element 40 of the interfacing layer 22 has a height H40 greater than or equal to 10 nm. Preferentially, further, each element 40 of the interfacing layer 22 has a height H40 greater than or equal to 0.5 µm. Advantageously, each element 40 of the interfacing layer 22 has a height H40 comprised between 10 nm and 3 µm .

Such a height H40 of the elements 40 makes it possible to increase the surface area of contact with the electrode 21, and thus to improve the electrical contact between the substrate 20 and the electrode 21. Such a height H40 of the elements 40 also makes it possible to limit the mechanical stresses associated with the volume variations of the intercalation material MI of the electrode 21.

As can be seen in FIG. 3, the interfacing layer 22 consists of n discrete elements 40 forming the array 38. The first face 201 of the substrate 20 is accordingly not entirely covered by the plurality of elements 40.

The interfacing layer 22 is characterized by a covering ratio R(r/s) of the first face 201 of the substrate 20.

The covering ratio R(r/s) corresponds to the ratio between the surface area A22 of the interfacing layer 22 and the surface area A201 of the first face 201 of the substrate 20.

The surface area A22 of the interfacing layer 22 is defined as the sum of the surface areas A401 of the base 401 of the n elements 40 of the interfacing layer 22. The surface area A22 of the interfacing layer 22 is calculated according to the following formula:

$$A 22 = {\sum }_{i = 1}^{n} A {401}_{i}$$

where i denotes the i-th area A401.

According to the example described, the bases 401 are all identical and the surface area A22 of the interfacing layer is calculated according to the following formula:

$$\text{A22 = n} \times \text{A401}$$

The covering ratio R(r/s) is calculated according to the following formula:

$$\text{R} \left(\text{r} / \text{s}\right) = \text{A22} / \text{A201}$$

Preferentially, the covering ratio R(r/s) is comprised between 0.1 and 0.9. Advantageously, the covering ratio R(r/s) is comprised between 0.2 and 0.5.

The fact that the first face 201 of the substrate 20 is not entirely covered by the interfacing layer 22 can be used for generating a relief on the first face 201 of the substrate 20, which makes it possible to increase the contact surface with the electrode 21, and therefore to improve the electrical contact between the substrate 20 and the electrode 21. In this way, the mechanical stresses generated by the volume variations of the active material of the electrode 21 during the operation of the cell 10, can be limited. The modulation of the covering ratio R(r/s) can be further used for decreasing the electrical resistance between the substrate 20 and the electrode 21 compared with the case where the covering ratio is equal to 1.

The elements 40 of the interfacing layer 22 are produced by depositing a third composition C3 on the first face 201 of the substrate 20. Preferentially, the elements 40 of the interfacing layer 22 are produced by coating the third composition C3 on the first face 201 of the substrate 20.

The third composition C3 includes a third conducting additive AC3 and, if appropriate, a third binder material ML3. Advantageously, the third composition C3 consists of a third conducting additive AC3 and a third binder material ML3.

The third conducting additive AC3 includes one or a plurality of conducting elements for improving the electronic conductivity.

The third conducting additive AC3 e.g. is chosen from carbon, carbon black, graphite, graphene, carbon nanotubes, activated carbon fibers, non-activated carbon nanofibers, metal flakes, metal powders, metal fibers and electrically conducting polymers.

The third composition C3 comprises a concentration by weight of third conducting additive AC3 greater than or equal to 20%.

Preferentially, the third composition C3 comprises a concentration by weight of third conducting additive AC3 less than or equal to 90%.

Advantageously, the concentration by weight of third conducting additive AC3 comprised in the third composition C3 is comprised between 40% and 70%.

The third binder material ML3 consists of one or a plurality of polymers chosen from thermoplastic polymers, thermosetting polymers, elastomers and mixtures thereof.

Thermoplastic polymers, thermosetting polymers and elastomers are such as defined hereinabove.

The third composition C3 comprises a concentration by weight of a third binder material ML3 greater than or equal to 10%.

Preferentially, the third composition C3 comprises a concentration by weight of a third binder material ML3 less than or equal to 80%.

Advantageously, the concentration by weight of a third binder material ML3 comprised in the third composition C3 is comprised between 30% and 60%.

The n elements 40 of the interfacing layer 22 are arranged according to different variants.

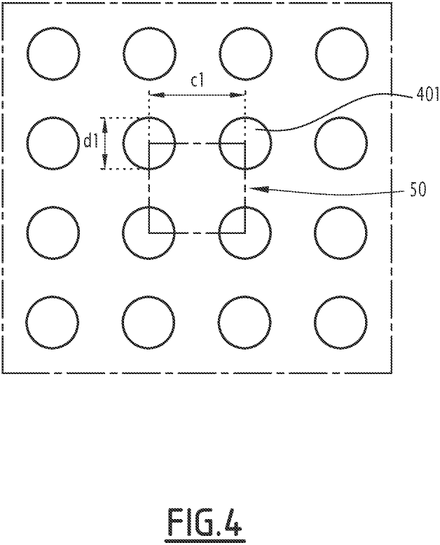

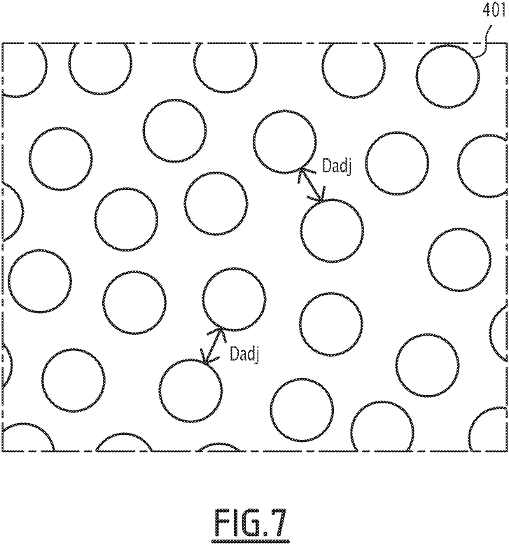

According to the examples shown in FIGS. 4, 5 and 6, the n elements 40 of the interfacing layer 22 are arranged in corresponding elementary meshes, each elementary mesh being identical. According to the example shown in FIG. 7, the n elements 40 of the interfacing layer are distributed randomly on the first face 201 of the substrate 20.

According to the variant shown in FIG. 4, the elementary mesh 50 of the interfacing layer 22 is provided by four bases 401 arranged in a square.

In this way, the four vertices of the elementary mesh 50 form a square, each vertex being the center of a base 401.

The elementary mesh 50 has a side defined by a segment connecting the center of two adjacent bases 401.

The side of the elementary mesh 50 has a length c1 comprised between 400 µm and 3500 µm , preferentially between 600 µm and 2000 µm.

The array 38 is a set corresponding to the periodic repetition of the elementary mesh 50 along directions X and Y, the directions X and Y being mutually normal and normal to the direction Z.

The functioning of the anode 16 according to the variant shown in FIGS. 3 and 4 is in accordance with the functioning of the anode 16 as shown in FIG. 2.

The advantages of the anode 16 according to such variant are similar to the advantages of the anode 16 as shown in FIG. 2.

Furthermore, the organization of the interfacing layer 22 in a plurality of elements 40 arranged in an array formed by an elementary mesh provides a homogeneous anode over the entire dimension thereof. The repeatability of the pattern provides better anode reproducibility and better electrochemical performance reproducibility.

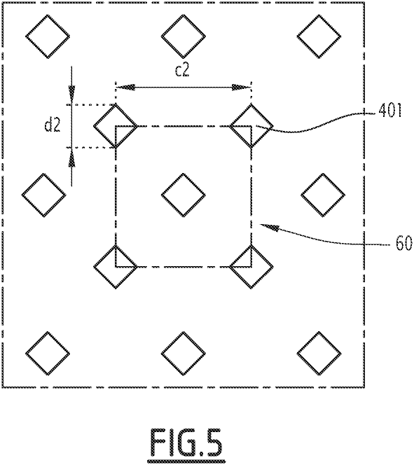

According to the variant shown in FIG. 5, the bases 401 of the elements 40 of the interfacing layer 22 are squares.

Each base 401 is defined by a diagonal with a length d2. The length d2 varies between 200 µm and 1200 µm , preferentially between 500 µm and 1000 µm.

The elementary mesh 60 of the interfacing layer 22 is provided by five bases 401 forming a centered square.

In this way, the four vertices of the elementary mesh 60 form a square, each vertex being the center of a base 401, and the center of the fifth base 401 is arranged at the center of said square.

The elementary mesh 60 has a side defined by a segment connecting the center of two adjacent bases 401 chosen from the four bases 401 forming the square.

The side of the elementary mesh 60 is defined by a length c2. The length c2 varies between 400 µm and 3700 µm , preferentially between 600 µm and 2200 µm.

The array 38 is then a set corresponding to the periodic repetition of the elementary mesh 60 along directions X and Y, the directions X and Y being mutually normal and normal to the direction Z.

The functioning of the anode 16 according to the variant shown in FIG. 5 is in accordance with the functioning of the anode 16 as shown in FIGS. 3 and 4.

The advantages of the anode 16 according to such variant are similar to the advantages of the anode 16 as shown in FIGS. 3 and 4.

Furthermore, the organization of the n staggered elements 40 can be used for increasing the covering ratio R(r/ s), and hence for increasing the contact surface with the electrode 21. The fact that the bases 401 of the elements 40 are squares can be further used for increasing the covering ratio R(r/s).

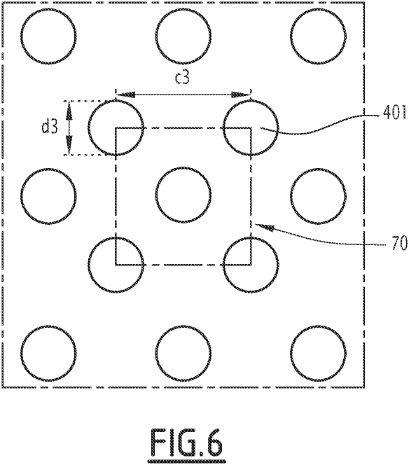

In another example shown in FIG. 6, the elementary mesh consists of an elementary mesh 70 corresponding to the elementary mesh 60 according to FIG. 5 wherein the bases 401 are disks.

Each base 401 is defined by a diameter with a length d3. The length d3 varies between 200 µm and 1200 µm , preferentially between 500 µm and 1000 µm.

The elementary mesh 70 has a side defined by a length c3. The length c3 varies between 400 µm and 3500 µm , preferentially between 600 µm and 2000 µm.

The array 38 is then a set corresponding to the periodic repetition of the elementary mesh 70 along directions X and Y, the directions X and Y being mutually normal and normal to the direction Z.

The functioning of the anode 16 according to the variant shown in FIG. 6 is in accordance with the functioning of the anode 16 as shown in FIGS. 3 and 4.

The advantages of the anode 16 according to such variant are similar to the advantage of the anode 16 as shown in FIGS. 3 and 4.

In addition, the organization of the n elements 40 in staggered fashion makes it possible to increase the covering ratio R(r/s), and therefore to increase the contact surface with the electrode 21.

According to the example shown in FIG. 7, the n elements 40 of the interfacing layer 22 are randomly distributed on the first face 201 of the substrate 20.

Two adjacent elements 40 are separated by a distance Dadj, the distance Dadj being the smallest distance between two points of the two adjacent elements 40.

Two adjacent elements 40 form a pair of adjacent elements 40, the pair of adjacent elements 40 consisting of a first element 40 and a second element 40. Each element 40 of the interfacing layer 22 being comprised in at least one pair of adjacent elements 40. The distance Dadj represents the smallest distance between a point on the base 401 of the first element 40 of the pair of adjacent elements 40 and a point on the base 401 of the second element 40 of the pair of adjacent elements 40.

The distance Dadj of each pair of adjacent elements 40 of the interfacing layer 22 is comprised between 200 µm and 2500 µm, preferentially between 400 µm and 1000 µm.

In other words, each element 40 of the interfacing layer 22 is separated from the set of elements 40 adjacent thereto by a distance Dadj comprised between 200 µm and 2500 µm, preferentially between 400 µm and 1000 µm.

Each base 401 has the same shape, the shape being chosen from one of the bases 401 according to FIGS. 4, 5 and 6.

The functioning of the anode 16 according to the variant shown in FIG. 7 is in accordance with the functioning of the anode 16 as shown in FIG. 3.

The advantages of the anode 16 according to such variant are similar to the advantages of the anode 16 as shown in FIG. 3.

Moreover, the organization of the interfacing layer 22 into a plurality of elements 40 arranged in an array provides a homogeneous anode over the entire dimension thereof.

It further results from the examples according to FIGS. 3, 4, 5, 6 and 7 that the base 401 of each element 40 of the interfacing layer 22 is a polygon or an oval.

The geometry of the base 401 of the elements 40 can be used for adjusting the covering ratio R(r/s).

Each base 401 of the elements 40 of the interfacing layer 22 is in contact with the first face 201 of the substrate 20. Each element 40 further has a surface 402. The surfaces 402 of the elements 40 are not in contact with the first face 201 of the substrate 20.

Preferentially, the surface 402 of each element 40 has a roughness.

The roughness of the surface 402 of each element 40 represents the amplitude of the relief of the surface 402 of each element 40.

The roughness of the surface 402 of each element 40 is determined according to the same method as the method described above for determining the roughness of the second face 222 of the interfacing layer 22.

Preferentially, the roughness of the surface 402 of each element 40 is comprised between 10 nm and 10 µm, preferentially between 0.5 µm and 9 µm , preferentially between 0.5 µm and 8 µm , more preferentially between 0.5 µm and 6 µm, advantageously between 1 µm and 6 µm , more advantageously between 2 µm and 6 µm.

The roughness of the surface 402 of each element 40 is modulated by the size, shape and quantity of the constituents of the composition C3.

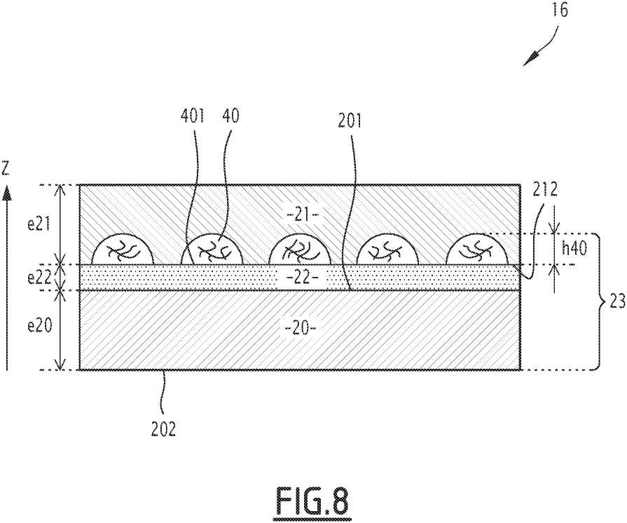

According to another variant shown in FIG. 8, the anode 16 comprises two interfacing layers 22.

The two interfacing layers 22 are overlaid one on top of the other along the stacking direction Z.

The first interfacing layer 22 is in contact with the first face 201 of the substrate 20 and the second interfacing layer 22 is in contact with the face 212 of the electrode.

The first interfacing layer 22 corresponds to the interfacing layer 22 according to FIG. 2.

The second interfacing layer 22 corresponds to the interfacing layer 22 according to FIGS. 3 to 6.

More generally, it results from the example of the anode 16 according to FIG. 8 that the anode 16 comprises a number p of interfacing layers 22, p being an integer greater than or equal to two. Preferentially, p is comprised between 2 and 4.

The p interfacing layers 22 of the anode 16 are overlaid on top of each other along the stacking direction Z.

The p interfacing layers 22 of the anode 16 are deposited successively on top of each other by depositing, preferentially by coating, the second composition C2 or the third composition C3.

The second composition C2 and the third composition C3 are different for each of the p interfacing layers 22.

The functioning of the anode 16 according to such variant is in accordance with the functioning of the anode 16 as shown in FIGS. 2 to 7.

The advantages of the anode 16 are similar to the advantages of the anode 16 as shown in FIGS. 2 and 7.

Furthermore, the presence of at least two interfacing layers 22 can be used for generating more relief than in the case where a single interfacing layer 22 is present, which makes it possible to increase the contact area with the electrode 21, and hence to improve the electrical contact between the substrate 20 and the electrode 21. By modulating the compositions as well as the covering ratio of the at least two interfacing layers, it is possible to shape the interfaces between the different layers and to increase the electrochemical performance of the anode 16. The composition of the first interfacing layer 22 can e.g. improve the adhesion of the electrode 21 to the substrate 20, while the composition of the second interfacing layer 22 would make it possible to significantly increase the conductivity within the anode 16. Thus, it is possible to add the benefits provided by each interfacing layer 22 and to maximize the performance of the anode 16 due to the interactions thereof.

Preferentially, in all embodiments, the interfacing layer 22 has a roughness.

The interfacing layer 22 has a face which is not in contact with the first face 201 of the substrate 20.

E.g. the face of the interfacing layer 22 which is not in contact with the first face 201 of the substrate 20 corresponds to the face 221 shown in FIG. 2, or to all the faces 402 of the discrete elements 40 shown in FIG. 3.

The roughness of the interfacing layer 22 represents the amplitude of the relief of the face of the interfacing layer 22 which is not in contact with the first face 201 of the substrate 20.

The roughness of the face of the interfacing layer 22 which is not in contact with the first face 201 of the substrate 20 is determined by white light interferometry measurement, e.g. by means of a nanometric non-contact surface topography station (OptoSurf brand). The topography station can be used for reconstituting in 2D and 3D, the face of the interfacing layer 22 which is not in contact with the first face 201 of the substrate 20 so as to determine the roughness thereof.

The roughness of the interfacing layer 22 is defined from at least two distinct areas of the face of the interfacing layer 22 which is not in contact with the first face 201 of the substrate 20. For each zone, the amplitude of the reliefs Rt is determined, i.e. the distance between the highest point and the lowest point of said zone.

The roughness of the interfacing layer 22 is equal to the mean value, denoted by Rtm, of at least two relief amplitude values Rt, each relief amplitude value Rt corresponding to a distinct zone of the face of the interfacing layer 22 which is not in contact with the first face 201 of the substrate 20.

The advantage of dividing the surface of the face of the interfacing layer 22 which is not in contact with the first face 201 of the substrate 20 into at least two distinct zones for measuring the mean of the amplitude of the reliefs is to limit the uncertainty associated with a possible inhomogeneity of the face of the interfacing layer 22 which is not in contact with the first face 201 of the substrate 20.

The surface of each distinct zone of the face of the interfacing layer 22 which is not in contact with the first face 201 of the substrate 20 defined for determining the roughness of the interfacing layer 22 measures e.g. 40,000 µm².

Preferentially, the roughness of the interfacing layer 22 is comprised between 10 nm and 10 µm, preferentially between 0.5 µm and 9 µm, preferentially between 0.5 µm and 8 µm , more preferentially between 0.5 µm and 6 µm, advantageously between 1 µm and 6 µm , more advantageously between 2 µm and 6 µm.

The roughness of the interfacing layer 22 can be used for generating a better electrical percolation within the electrode 21 and for increasing the electron exchange surface area with the current collector 23.

Preferentially, in all embodiments, the interfacing layer 22 has a covering ratio R(ci/s) of the first face 201 of the substrate 20 which is strictly less than 1. The first face 201 of the substrate 20 is thus not entirely covered by the interfacing layer 22.

The interfacing layer 22 has a face in contact with the first face 201 of the substrate 20.

E.g. the face of the interfacing layer 22 in contact with the first face 201 of the substrate 20 corresponds to the face 222 shown in FIG. 2, or to all the bases 401 of the discrete elements 40 shown in FIG. 3.

The face in contact with the first face 201 of the substrate 20 has a surface area A22.

The first face 201 of the substrate 20 has a surface area A201.

The covering ratio R(ci/s) of the first face 201 of the substrate 20 corresponds to the ratio between the surface area A22 of the face in contact with the first face 201 of the substrate 20 and the surface area A201 of the first face 201 of the substrate 20, and is calculated according to the following formula:

$$\text{R} \left(\text{ci} / \text{s}\right) = \text{A22} / \text{A201}$$

The covering ratio R(ci/s) is preferentially greater than or equal to 0.1.

Preferentially, the covering ratio R(ci/s) is comprised between 0.1 and 0.9, advantageously between 0.2 and 0.9.

Modulating the covering ratio of the first face 201 of the substrate 20 makes it possible to decrease the electrical resistance between the substrate 20 and the electrode 21 compared with the case where the substrate 20 is entirely covered by the interfacing layer 22 (covering ratio equal to 1).

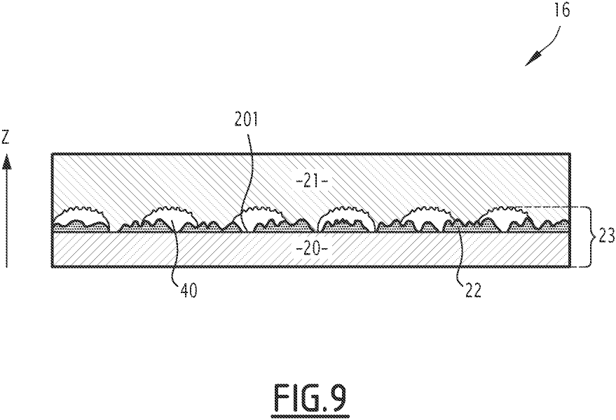

According to a variant shown in FIG. 9, the current collector 23 associated with the electrode 21 for forming the anode 16, comprises two interfacing layers 22.

The first and second interfacing layers 22 have both a roughness as defined above, and a covering ratio of the first face 201 of the substrate 20 that is strictly less than 1.

Without wishing to be bound by any theory, the inventors believe that due to the fact that the electrons have at least four possible paths to go from the electrode 21 to the substrate 20 (moving directly from the electrode 21 to the substrate 20 without crossing through any interfacing layer, crossing only through the first interfacing layer 22, crossing only through the second interfacing layer 22 or crossing through the two interfacing layers 22, as shown in FIG. 9), each path having different conductivity characteristics allowing electrons to take one path or paths in a preferred manner, the transmission of electrons is improved.

The first face 201 of the substrate 20 is preferentially substantially smooth. “Substantially smooth” means that the roughness of the surface of the substrate 20, measured with a profilometer, is less than or equal to 500 nm, preferentially less than or equal to 200 nm, preferentially less than or equal to 80 nm, more preferentially less than or equal to 50 nm, advantageously less than or equal to 20 nm.

The thickness e22 of the interfacing layer 22 is preferentially between 10 nm and 10 µm. If the thickness of the interfacing layer 22 is thicker than 10 µm , the interfacing layer then occupies a volume and has too great a weight to the detriment of the materials forming the electrode, which would induce a loss in energy density within the electrochemical cell. On the other hand, the minimum thickness of the interfacing layer 22 is controlled by the application method and/or the composition from which same is obtained. An interfacing layer e. g. produced by liquid coating can have a thickness greater than or equal to 100 nm.

Preferentially, the thickness e22 of the interfacing layer 22 is greater than or equal to 100 nm.

Advantageously, the thickness e22 of the interfacing layer 22 is comprised between 0.5 µm and 6 µm .

Throughout the present description, the thickness of the interfacing layer 22 corresponds to the maximum thickness of said interfacing layer 22.

In addition to improving the exchange surface of the current collector 23 with the electrode 21, the presence of at least one interfacing layer 22 makes it possible to limit the deterioration and delamination of the anode 16, caused by the volume expansion of the intercalation material of the electrode 21. Such phenomenon is particularly very present in silicon anodes, where the active material can reach volume changes of 300%.

Concrete, but in no way limiting examples illustrating embodiments of the collector will now be given.

### EXAMPLES

### Example 1: Measurement of the Roughness of the Interfacing Layer According to The Composition Thereof

The roughness of three different interfacing layers was measured. The composition of the three interfacing layers differs in that the proportion of fibers among the conducting additives is different in each of the layers, which makes it possible to evaluate the impact of the shape of the additives on the roughness of the interfacing layers. The compositions of the three interfacing layers were as follows:
Formulation A: 0%w of fibers for 100%w of conducting additives
Formulation B: 23%w of fibers for 100%w of conducting additives
Formulation C: 39%w of fibers for 100%w of conducting additives
The remainder of conducting additives consists of ovoid particles.

5 Rtm measurements were performed on each interfacing layer, using the method described in the description. The Rtm measurement is the average of the Rt measurements for each zone, with the analysis surface of each interface layer divided into 25 zones.

The results obtained are presented in the following table:

| Rtm (µm) | Formulation A | Formulation B | Formulation C |
|---|---|---|---|
| Analysis 1 | 3.272 | 6.338 | 7.017 |
| Analysis 2 | 3.289 | 6.853 | 7.322 |
| Analysis 3 | 3.241 | 6.895 | 7.959 |
| Analysis 4 | 2.938 | 6.899 | 7.899 |
| Analysis 5 | 3.421 | 7.425 | 7.643 |
| Mean value | 3.232 | 6.882 | 7.568 |
| Standard deviation | 0.178 | 0.385 | 0.398 |

Such results demonstrate that it is possible to modulate the roughness of the interfacing layer by the choice of the constituents of the composition and in particular via conducting additives. Herein, it is demonstrated that the particles in the form of fibers generate a greater amplitude of the reliefs and that the higher the mass quantity of fibers in the composition, the more the amplitude increases.

### Example 2: Evaluation of the Adhesion of the Interfacing Layer to the Substrate

A characterization method has been developed for evaluating the quality of adhesion of the interfacing layer to the substrate. For this purpose, a peel strength characterization was carried out on a substrate coated with one or a plurality of interfacing layers using an adhesive. The protocol was as follows:
Application of the adhesive to the surface of the interfacing layer having a 180° peel adhesion force of 7.5 N/cm (ASTM D3330)
Pressing the adhesive onto the interfacing layer with a 2.6 kg roll. To ensure that the pressure for applying the adhesive onto the coating was the same for the different samples analyzed and to have better reproducibility of the test.
Removing the adhesive from the interfacing layer with a 180° peel.
Analyzing the appearance of the interfacing layer and the face of the adhesive in contact with the coating. If the interfacing layer has been completely removed from the substrate in certain zones and is present on the adhesive, there is delamination: the adhesion of the interfacing layer to the substrate is considered to be of poor quality.

3 current collector configurations were studied:
Sample A (EchA): an interfacing layer formed from a C2 composition with concentration by weight of binder material comprised between 60% and 65%, and a concentration by weight of conducting additive comprised between 35% and 40%, deposited on a copper foil with a covering ratio of 0.9.
Sample B (EchB): an interfacing layer formed from a C3 composition with concentration by weight of binder material comprised between 50% and 55%, and a concentration by weight of conducting additive comprised between 45% and 50%, deposited on a copper foil with a covering ratio of 0.27.
Sample C (EchC): first interfacing layer formed from a composition C2 identical to that of sample EchA, deposited on a copper foil and formation of a second interfacing layer formed from a composition C3 identical to sample EchB deposited on the interfacing layer with composition C2, thus forming an overlay of interfacing layers.

The nature of the binder material and the nature of the conducting additive are the same between composition C2 and composition C3.

The peel resistance of the interfacing layers of the different samples was characterized using the protocol detailed above.

The results obtained are presented in the following table:

| | | | |
|---|---|---|---|
| Current collector | EchA | EchB | EchC |
| Appearance of the interfacing layer after peeling | No delamination | Delamination | No delamination |

No delamination was found for the sample EchA, unlike for the sample EchB. The concentration of binder material is higher in composition C2 of the sample EchA than in composition C3 of the sample EchB. In this way, there is better adhesion of the interfacing layer to the copper foil. However, the sample EchC did not show delamination. Therefore, the interfacing layer with composition C3 has a good quality adhesion to the interfacing layer C2. Thus, the overlaying of different interfacing layers makes it possible to use a composition C3 the concentration of which of conducting additive is greater than in composition C2 and thereby generates a better interface quality and better electrical percolation in contact with the electrode. It can then be assumed that such overlay therefore provides a good quality of electrode/substrate adhesion via C2 and a boost of electrical performance via the layer obtained from the composition C3. It is thus demonstrated that the overlay of interfacing layers makes it possible to introduce a new interface, or even an interphase with a controlled conductivity gradient, which is more conducting, which was not possible without such layout. In the case of the sample EchC, the benefits provided by each interfacing layer are then cumulated, which makes it possible to maximize the performances of the anode due to the interactions thereof.

It can also be assumed that a similar result would be obtained if the nature of the binder material of the composition C3 was different from the nature of the composition C2. In fact, the choice of the binder material of the composition C3 can be adapted for better compatibility with the composition of the electrode and the adhesion of the assembly to the metal foil is provided by the composition C2. Thus, such layout can be used for widening the choice of the binder material and/or of the conducting additive and the concentration by weight in the composition of the interfacing layer in contact with the electrode because the latter is not limited by the ability thereof to adhere to the metal foil.

Moreover, the Applicant has shown that the geometry of the bases of the interfacing layer formed from the composition C3 has no significant impact on the results of the adhesion test.

### Example 3: Measurement of the Impedance of Electrochemical Cells Comprising Different Interfacing Layers

The electrochemical cells were produced with the following successive layers:
A current collector
An electrode deposited on the first current collector, the intercalation material MI being S′tile silicon, the binding material ML1 being PAA (ThermoFisher Scientific), the conducting additive AC1 being SUPER P®-Li carbon (Imerys Graphite & Carbon)
A separator, polypropylene membrane (Celgard® type), impregnated with an LiPF6 EC DMC 2% FEC electrolyte
A lithium metal counter-electrode.

All these elements having a multilayer system were mounted in a coin cell thus forming the electrochemical cell. In such an assembly, the electrode containing silicon cannot be considered as “negative” because the counter-electrode is metallic lithium.

Five electrochemical cells were produced, comprising five different current collectors:
A reference current collector (CCREF1), as a comparative example, consisting of a copper foil (Circuit Foil) with a thickness of 10 µm , without any interfacing layer,
A reference current collector 2 (CCREF2), as a second comparative example, consisting of a copper foil (Circuit Foil) with a thickness of 10 µm, and an interfacing layer with a covering ratio of 1 (100%), composed of 45% of conducting additive and 55% of binder material, with a thickness of 3 µm, and a roughness of 0.5 µm .
A current collector (CC1) according to the embodiment shown in FIG. 5, composed of a copper foil (Circuit Foil) with a thickness of 10 µm, as well as an interfacing layer structured in an array of a plurality of elements arranged in a staggered arrangement, the base of which of each element was a square, the covering ratio of 0.27 (i.e. 27% on the surface of the substrate), composed of 45% of conducting additive and 55% of binder material, with an element height of 3 µm .
A current collector (CC2) according to the embodiment shown in FIG. 4, composed of a copper foil (Circuit Foil) with a thickness of 10 µm , as well as an interfacing layer structured in an array of a plurality of elements, the base of which of each element being a disk, the covering ratio of 0.21 (i.e. 21% on the surface of the substrate), composed of 45% of conducting additive and 55% of binder material, with an element height of 3 µm .
A current collector (CC3) according to the embodiment shown in FIG. 6, composed of a copper foil (Circuit Foil) with a thickness of 10 µm , as well as an interfacing layer structured in an array of a plurality of elements arranged in a staggered arrangement, the base of which of each element being a disk, the covering ratio of 0.27 (i.e. 27% on the surface of the substrate), composed of 45% of conducting additive and 55% of binder material, with an element height of 2 µm.

The electrochemical performance of the cells was characterized by a multi-channel potentiostat VMP3 (Biologic).

A formation cycle between 1.2 V and 10 mV vs Li/Li⁺ at the speed C/20 (calculated on the theoretical capacity) was carried out in order to form the solid electrolyte interphase layer (SEI) on the silicon electrode and to make sure that the electrode was functional.

Electrochemical Impedance Spectroscopy (EIS) spectra were then recorded over the frequency range from 500 kHz to 10 mHz, at an amplitude of 5 mV.

Electrochemical impedance spectroscopy is a useful technique for studying electrochemical and physical phenomena at the current collector/electrode/electrolyte interfaces of the electrochemical cell. Same is based on the study of the transfer function of the electrochemical systems in stationary and linear regimes. For non-linear systems to be placed in such conditions, a small amplitude perturbation is applied around the assumed quasi-stationary functioning point (equilibrium system). In the present work, impedance measurements were made by applying a sinusoidal potential perturbation with an amplitude of 5 mV around the equilibrium voltage of the system.

The representation of the impedance in the Nyquist plane (not shown) made it possible to emphasize the different phenomena involved in the cells studied.

Indeed, the impedance spectra obtained (not shown) correspond to the different contributions within an electrochemical cell: contact resistances which may result from the assembly of the electrochemical cell and the current collector, charge transfer resistance, diffusion of Li+ ions within the electrodes, etc. In order to compare the resulting resistances of the current collector, the difference between 2 different frequency points corresponding to the width of the semicircle obtained by all the above-mentioned contributions was measured, allowing the resistance “R EIS”, also called impedance, to be obtained.

The results obtained are presented in the table below:

| Current collector | CCREF1 | CCREF2 | CC1 | CC2 | CC3 |
|---|---|---|---|---|---|
| Impedance Ω.cm2) | 1.90 | 1.90 | 1.67 | 1.74 | 1.73 |

The above results illustrate the fact that the impedance differences for the current collectors can be related to the covering ratio. Indeed, a lower impedance is found for the current collectors with a coating having a covering ratio of 0.27 (CC1 and CC3) compared with the current collector having a covering ratio of 0.21 (CC2).

Such differences can further be related to the height of the elements forming the interfacing layer, because the height of the elements of the current collector CC1 is greater than the height of the elements of the current collector CC3 and thus generates a larger electrical contact surface with the electrode. Also, the geometry and the surface area of each element forming the interfacing layer, can participate in the variations of the measured impedances.

1. A current collector for anode, the current collector including:
- a substrate with a first face, and
- at least one interfacing layer with a thickness less than 10 micrometers, in contact with the first face of the substrate, the interfacing layer having a roughness the depth of which is comprised between 0.5 micrometers and 10 micrometers.

2. The current collector according to claim 1, wherein the interfacing layer has a second face in contact with the first face of the substrate, the second face of the interfacing layer having a surface area and the first face of the substrate having a surface area, the ratio between the surface area of the second face of the interfacing layer and the surface area of the first face of the substrate being comprised between 0.1 and 1.

3. The current collector according to claim 1, wherein the interfacing layer is formed by coating a second composition, the second composition comprising a second binder material and a second conducting additive.

4. The current collector according to claim 1, wherein the interfacing layer consists of an array including a plurality of elements arranged on the first face of the substrate, each element being separated from another adjacent element by a distance Dadj comprised between 200 micrometers and 2500 micrometers, the distance Dadj between two adjacent elements being the smallest distance between a point of a first element and a point of a second element adjacent to the first element.

5. The current collector according to claim 4, wherein the interfacing layer is formed by coating a third composition, the third composition comprising a third conducting additive.

6. The current collector according to claim 4, wherein each element has a base, the base of each element being a polygon or a disk or an oval.

7. The current collector according to claim 6, wherein the base of the elements of the interfacing layer has a covering ratio of the first face of the substrate comprised between 0.1 and 0.9.

8. The current collector according to claim 4, wherein each element has a height less than or equal to 10 micrometers.

9. The current collector according to claim 1, wherein the interfacing layer has a covering ratio of the first face of the substrate strictly less than 1.

10. The current collector according to claim 2, further comprising at least one second interfacing layer, the second interfacing layer consisting of an array including a plurality of elements arranged on the first face of the substrate, each element being separated from another adjacent element by a distance Dadj comprised between 200 micrometers and 2500 micrometers, the distance Dadj between two adjacent elements being the smallest distance between a point of a first element and a point of a second element adjacent to the first element, the first interfacing layer and the second interfacing layer being overlaid on top of each other.

11. An anode for electrochemical cell, the anode including:
- a current collector according to claim 1, and
- an electrode produced according to a first composition, the first composition including an intercalation material, a first binder material and a first conducting additive, the intercalation material comprising silicon, the electrode having a face, the first face of the substrate and the face of the electrode being opposite and the interfacing layer being arranged between the substrate and the electrode and in contact with the first face of the substrate and the face of the electrode.

12. The anode according to claim 11, wherein the silicon concentration of the intercalation material is greater than or equal to 30% by weight.

13. The anode according to claim 11, wherein the intercalation material is silicon.

14. An electrochemical cell comprising a collector according to claim 1.

15. An energy storage device including at least one cell according to claim 14.

16. A method for manufacturing a current collector for anode, the method including:
- a step of providing a substrate with a first face, and
- a step of depositing by coating, at least one interfacing layer on the first face of the substrate, the interfacing layer having a thickness less than 10 micrometers, the interfacing layer having a roughness the depth of which is comprised between 0.5 micrometers and 10 micrometers.

17. A method for manufacturing an anode for an electrochemical cell, the method comprising:
- a step of implementing the steps of the method for manufacturing a current collector for anode according to claim 15,
- a step of preparing a first composition including an intercalation material, a first binder material and a first conducting additive, the intercalation material comprising silicon, and
- a step of depositing by coating the first composition on the interfacing layer in order to obtain an electrode with a face, the first face of the substrate and the face of the electrode being opposite, and the interfacing layer being in contact with the first face of the substrate and the face of the electrode.

18. The current collector of claim 4, wherein the third composition further comprises a third binder material.

19. The current collector according to claim 6, wherein the base of the elements of the interfacing layer has a covering ratio of the first face of the substrate comprised between 0.2 and 0.5.

20. The anode according to claim 11, wherein the silicon concentration of the intercalation material is greater than or equal to 60% by weight.
